(19) United States
(12) Patent Application Publication
(10) Pub. No.: US 2018/0121071 A1
(43) Pub. Date: May 3, 2018

(54) VEHICLE DISPLAY BASED ON VEHICLE SPEED

(71) Applicant: Ford Global Technologies, LLC, Dearborn, MI (US)

(72) Inventors: Hafiz Shafeek Khafagy, Dearborn, MI (US); Ahmed Awadi, Farmington Hills, MI (US); Siraj Siddiqui, Lasalle (CA)

(21) Appl. No.: 15/343,120

(22) Filed: Nov. 3, 2016

(51) Int. Cl. G06F 3/0484; G06F 3/041; B60K 35/00; G01P 3/44

(52) U.S. Cl. CPC G06F 3/04847; G06F 3/0412; B60K 35/00; B60K 2350/20; B60K 2350/1028; B60K 2350/104; B60K 2350/1096; G01P 3/44

(57) ABSTRACT

Methods, apparatus, and computer storage media are disclosed for vehicle display based on vehicle speed. An example vehicle includes a speed sensor to measure a vehicle speed, a display controller to compare the vehicle speed to a threshold, and a display. The example display is to present, in response to the vehicle speed being less than the threshold, a first button at a button location. The example display is to present, in response to the vehicle speed being greater than or equal to the threshold, a second button at the button location.

### TECHNICAL FIELD

The present disclosure generally relates to vehicle displays and, more specifically, vehicle display based on vehicle speed.

### BACKGROUND

Generally, vehicles include center consoles and dashboards. Oftentimes, a center console and a dashboard of a vehicle includes input devices (e.g., buttons, knobs, etc.) that receive information from a user (e.g., a driver) and output devices (e.g., meters, gauges, etc.) that provide information to the user. Some vehicles include a display located in the center console or the dashboard that displays output information to enable the user to monitor one or more instruments (e.g., a HVAC system, a radio, etc.) and/or settings (e.g., driver settings, temperature settings, etc.) of the vehicle.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for vehicle display based on vehicle speed. An example disclosed vehicle includes a speed sensor to measure a vehicle speed, a display controller to compare the vehicle speed to a threshold, and a display. The example display is to present, in response to the vehicle speed being less than the threshold, a first button at a button location. The example display is to present, in response to the vehicle speed being greater than or equal to the threshold, a second button at the button location.

An example disclosed method for presenting a button on a vehicle display includes comparing, via a controller, a speed of a vehicle to a threshold. The example disclosed method includes presenting, via a display of the vehicle, a first button at a button location in response to the speed being less than the threshold. The example disclosed method includes presenting a second button at the button location in response to the speed being greater than or equal to the threshold.

An example disclosed tangible computer storage medium includes instructions, which, when executed, cause a machine to compare, via a controller, a speed of a vehicle to a threshold. The example disclosed instructions cause the machine to present, via a display of the vehicle, a first button at a button location in response to the speed being less than the threshold. The example disclosed instructions cause the machine to present a second button at the button location in response to the speed being greater than or equal to the threshold.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example vehicle including a display in accordance with the teachings herein.

FIG. 2A depicts a display of the vehicle of FIG. 1 presenting an interface having a first button at a button location.

FIG. 2B depicts the display presenting the interface of FIG. 2A having a second button at the button location.

FIG. 3 is a block diagram of electronic components of the vehicle of FIG. 1.

FIG. 4 is a flowchart of an example method for presenting an interface via the display of FIGS. 2A and 2B based on a speed of the vehicle of FIG. 1.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Generally, vehicles include center consoles and dashboards. Oftentimes, the center console and/or the dashboard of a vehicle includes input devices (e.g., buttons, knobs, etc.) that receive information from a user (e.g., a driver) and output devices (e.g., meters, gauges, etc.) that provide information to the user to enable the user to monitor and control instruments (e.g., a HVAC system, a radio, etc.) and/or settings (e.g., driver settings, temperature settings, etc.) of the vehicle. For example, the center console may include a knob that enables a user to adjust a setting of the HVAC system and a screen to display a current temperature within the vehicle.

Some vehicles include a touch screen located in the center console or the dashboard that presents a plurality of input devices and/or output devices of the vehicle to a user (e.g., a driver). In some instances, the number of input devices and output devices that may be presented via the touch screen is great. In such instances, a driver may potentially find it difficult to find, view, and/or interact with each of the input devices and/or output devices available via the touch screen.

The example apparatus, methods, and computer storage media disclosed herein include a display (e.g., a touch screen) of a vehicle that presents buttons based on a speed of the vehicle to enable a driver to easily navigate to and interact with input device(s) and/or output device(s) presented via the display while driving. For example, the display presents a first button (e.g., a first navigation button) in a menu when the vehicle is moving below a threshold speed and replaces the first button with a second button (e.g., a second navigation button) when the vehicle is move at or above the threshold speed. The first button directs the user to a first interface that presents features associated with a slow-moving or stationary vehicle, and the second button directs the user to a second interface that presents features associated with faster-moving vehicles.

An example vehicle disclosed herein includes a vehicle speed sensor to measure a vehicle speed, a display controller to compare the vehicle speed to a threshold speed (e.g., about 3 miles per hour), and a display (e.g., a touch screen). The display presents a first button at a button location of an interface in response to the vehicle being less than the threshold speed and presents a second button at the button location of the interface in response to the vehicle being greater than or equal to the threshold speed. That is, the display presents the first button or the second button at the button location of the menu based on the speed of the vehicle. The first button is associated with a first vehicle feature, and the second button is associated with a second vehicle feature. For example, the first button may be associated with a start-stop engine system or any other vehicle feature that is utilized when the vehicle is stopped and/or moving slowly. The second button may be associated with a lane-assist system or any other vehicle feature that is utilized when the vehicle is moving at greater speeds.

In some examples, the controller of the disclosed examples detects when the first button and/or the second button is pressed by a user and measures a duration for which the first button and/or the second is pressed. Based on the duration, the display replaces and/or adjusts the interface being displayed. For example, when the controller determines that the first button is pressed for a duration less than a threshold duration (e.g., about 3 seconds), the display presents a first feature interface for the first vehicle feature (e.g., the start-stop engine system) associated with the first button. In contrast, when the controller determines that the first button is pressed for a duration greater than or equal to the threshold duration, the display adjusts the interface by replacing the first button with the second button such that the second button is presented at the button location. Similarly, when the controller determines that the second button is pressed for a duration less than the threshold duration, the display presents a second feature interface for the second vehicle feature (e.g., the lane-assist system) associated with the second button. Further, when the controller determines that the second button is pressed for duration greater than or equal to the threshold duration, the display replaces the second button with the first button such that the first button is displayed at the button location of the menu.

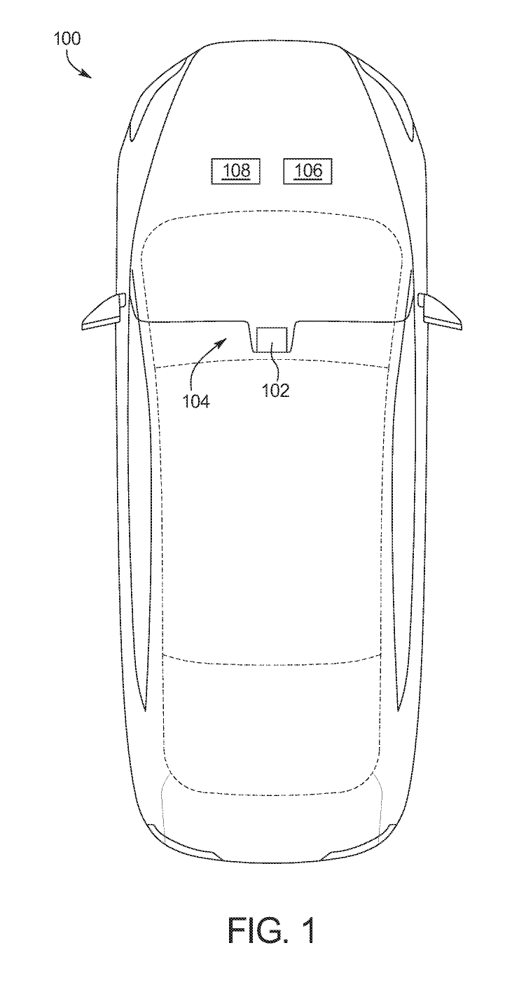

Turning to the figures, FIG. 1 illustrates an example vehicle 100 including a display 102 that presents interfaces in accordance with the teachings herein. The vehicle 100 may be a standard gasoline powered vehicle, a hybrid vehicle, an electric vehicle, a fuel cell vehicle, and/or any other mobility implement type of vehicle. The vehicle 100 includes parts related to mobility, such as a powertrain with an engine, a transmission, a suspension, a driveshaft, and/or wheels, etc. The vehicle 100 may be non-autonomous, semi-autonomous (e.g., some routine motive functions controlled by the vehicle 100), or autonomous (e.g., motive functions are controlled by the vehicle 100 without direct driver input). As illustrated in FIG. 1, the vehicle 100 includes the display 102 of an infotainment head unit 104, a vehicle speed sensor 106, and a display controller 108.

The display 102 of the vehicle 100 displays and/or navigates between interface(s) to be viewed and interacted with by a user. An interface presented by the display 102 may include input device(s), output device(s), and/or a menu of input device(s) and/or output device(s). In the illustrated example, the display 102 is a touch screen to enable a user to interact with (e.g., select) an input device by pressing a portion of the display 102 that corresponds to the input device. For example, to select a navigation button of an interface that navigates the user to another interface, the user presses the portion of the display 102 at which the navigation button is located. In other examples, the display 102 may be a non-touch display for which input instructions are received from a user via analog buttons that are located on the infotainment head unit 104 next to the display 102 and adjacent to corresponding information presented via the display 102.

The infotainment head unit 104 includes a center console and/or a dashboard of the vehicle 100 and provides an interface between the vehicle 100 and a user. The infotainment head unit 104 includes digital and/or analog interfaces (e.g., input devices and output devices) to receive input from and display information for the user(s). The input devices include, for example, a touch screen (e.g., the display 102), a control knob, an instrument panel, a digital camera for image capture and/or visual command recognition, an audio input device (e.g., cabin microphone), buttons, or a touchpad. The output devices may include instrument cluster outputs (e.g., dials, lighting devices), actuators, a heads-up display, a center console display (e.g., a liquid crystal display (LCD), an organic light emitting diode (OLED) display, a flat panel display, a solid state display, etc.) such as the display 102, and/or speakers. In the illustrated example, the infotainment head unit 104 includes hardware (e.g., a processor or controller, memory, storage, etc.) and software (e.g., an operating system, etc.) for an infotainment system (such as SYNC® and MyFord Touch® by Ford®, Entune® by Toyota®, IntelliLink® by GMC®, etc.). Additionally, the infotainment head unit 104 displays the infotainment system on, for example, the display 102.

The vehicle speed sensor 106 is a sensor that measures a speed of the vehicle 100. For example, the vehicle speed sensor 106 may be a tachometer that measures rate of rotation (e.g., revolutions per minute) of a wheel of the vehicle 100 to determine the vehicle speed.

The display controller 108 determines which interface, input device(s), and/or output device(s) are to be presented via the display 102 and instructs the display 102 to present the identified interface, input device(s), and/or output device(s). For example, the display controller 108 determines which interface is to be presented via the display 102 and/or which input device(s) and/or output device(s) are to be included in the presented interface based on the speed of the vehicle 100 and/or an input received from the user.

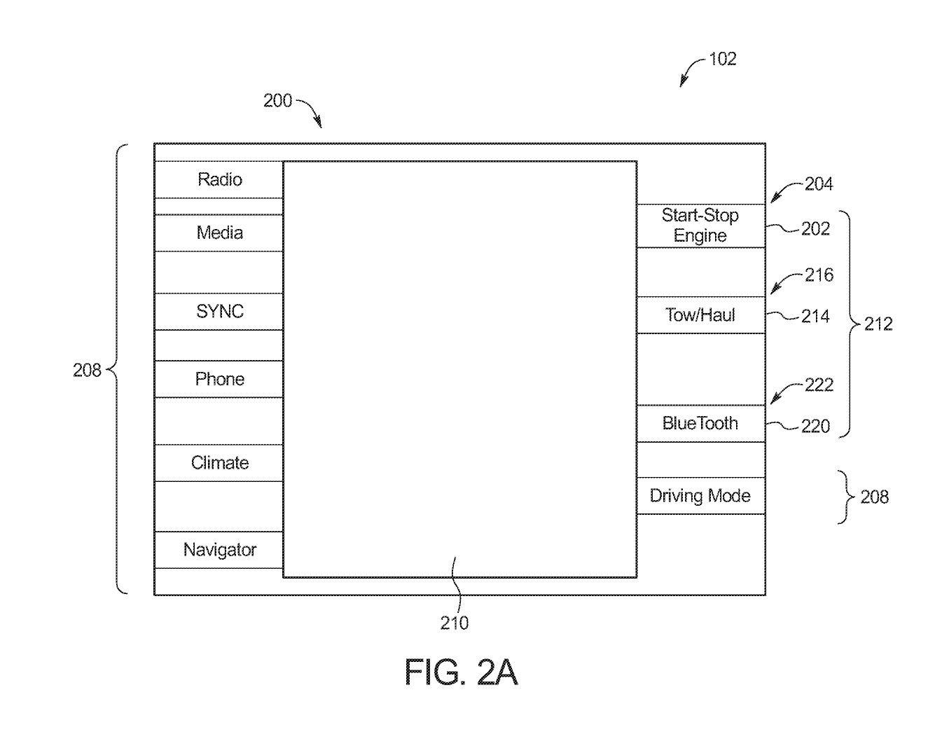

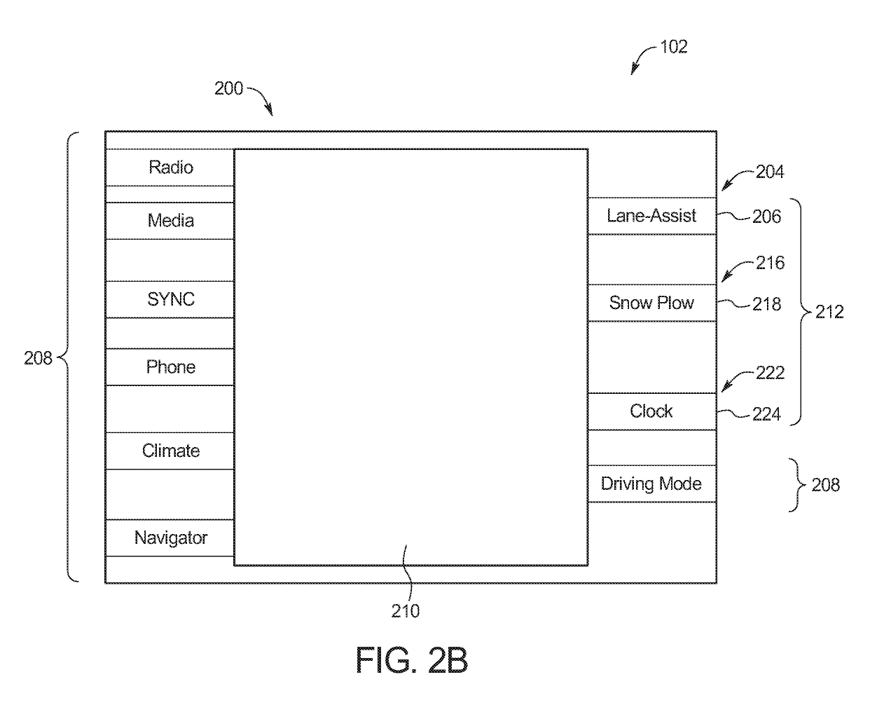

FIGS. 2A and 2B illustrate an interface 200 (e.g., a main menu) that is presented via the display 102 of the vehicle 100. More specifically, FIG. 2A depicts the display 102 presenting a first button 202 (e.g., a first navigation button) at a button location 204 (e.g., a first button location) of the interface 200, and FIG. 2B depicts the display 102 presenting a second button 206 (e.g., a second navigation button) at the button location 204 of the interface 200.

In the illustrated example, the interface 200 includes a first set of buttons 208 that are presented in the interface 200 as depicted in FIG. 2A and as depicted in FIG. 2B. For example, the first set of buttons 208 includes input devices such as a “Radio” button, a “Media” button, a “SYNC®” button, a “Phone” button, a “Climate” button, a “Navigator” button, and a “Driving” button. In other examples, the first set of buttons 208 may include more or less buttons and/or may include buttons associated with different features of the vehicle 100.

Further, the vehicle 100 includes a display area 210 that presents output information to a user. For example, the display area 210 presents output information to the user regarding feature(s) associated with one or more of the first set of buttons 208, one or more of a second set of buttons 212, and/or any other feature of the vehicle 100.

As illustrated in FIGS. 2A and 2B, the second set of buttons 212 included in the interface 200 may change over time. For example, the first button 202 (e.g., a “Start-Stop-Engine” button) of the second set of buttons 212 is presented at the button location 204 in FIG. 2A, and the second button 206 (e.g., a “Lane-Assist” button) of the second set of buttons 212 is presented at the button location 204 in FIG. 2B. In the illustrated example, a third button 214 (e.g. a third navigation button, a “Tow/Haul” button) of the second set of buttons 212 is presented at a button location 216 (e.g., a second button location) in FIG. 2A, and a fourth button 218 (e.g., a fourth navigation button, a “Snow Plow” button) of the second set of buttons 212 is presented at the button location 216 in FIG. 2B. Further, a fifth button 220 (e.g. a fifth navigation button, a “BlueTooth®” button) of the second set of buttons 212 is presented at a button location 222 (e.g., a third button location) in FIG. 2A, and a sixth button 224 (e.g., a sixth navigation button, a “Clock” button) of the second set of buttons 212 is presented at the button location 222 in FIG. 2B. In other examples, the second set of buttons 212 may include more or less buttons and/or may include buttons associated with different features of the vehicle 100.

In the illustrated example, the second set of buttons 212 presented via the display 102 changes based on the speed of the vehicle 100. In operation, the display controller 108 compares the vehicle speed (e.g., measured by the vehicle speed sensor 106) to a threshold speed. For example, the threshold speed is a predetermined value (e.g., 3 miles per hour) that is set as a factory setting. Additionally or alternatively, the threshold speed may be set and/or adjusted by a vehicle technician and/or a user of the vehicle 100.

In response to the display controller 108 determining that the vehicle speed is less than the threshold speed, the display 102 presents the interface 200 as depicted in FIG. 2A. For example, the display 102 presents the first button 202 at the button location 204, the third button 214 at the button location 216, and the fifth button 220 at the button location 222 when the vehicle speed is less than the threshold speed. In the illustrated example, the first button 202, the third button 214, and the fifth button 220 are associated with vehicle features that typically are utilized by a user when the vehicle 100 is stopped or moving slowly. For example, the first button 202 is associated with a start-stop engine system that autonomously shuts down an engine of the vehicle 100 when the vehicle 100 is stopped and restarts the engine upon the driver repressing a gas pedal of the vehicle 100.

In response to the display controller 108 determining that the vehicle speed is greater than or equal to the threshold speed, the display 102 presents the interface 200 as depicted in FIG. 2B. For example, the display 102 presents the second button 206 at the button location 204, the fourth button 218 at the button location 216, and the sixth button 224 at the button location 222 when the vehicle speed is greater than or equal to the threshold speed. In the illustrated example, the second button 206, the fourth button 218, and the sixth button 224 are associated with vehicle features that typically are utilized by a user when the vehicle 100 is moving quickly. For example, the second button 206 is associated with a lane-assist system that monitors the vehicle 100 and a lane along which the vehicle 100 is traveling to determine whether the vehicle 100 is drifting from its lane. In some examples, the lane-assist system includes a lane departure warning that warns the driver when the vehicle 100 is drifting from its lane. Additionally or alternatively, the lane-assist system includes a lane-keeping system that autonomously steers the vehicle 100 back into its lane upon detecting that the vehicle 100 is drifting.

In some examples, the display controller 108 utilizes hysteresis to prevent the display 102 from flickering between the interface 200 having the first button 202 (FIG. 2A) and the interface 200 having the second button 206 (FIG. 2B). For example, the threshold value includes an upper threshold and a lower threshold that is less than the upper threshold. The interface 200 presented transitions from including the first button 202 to including the second button 206 when the vehicle speed surpasses the upper threshold. Conversely, the interface 200 transitions from including the second button 206 to including the first button 202 when the vehicle speed drops below the lower threshold.

Further, the display controller 108 detects when one of the first set of buttons 208 and/or one of the second set of buttons 212 is selected by a user. In the illustrated example in which the display 102 is a touch screen, the display controller 108 detects when a user presses a portion of the touch screen that corresponds to a button. Further, the display controller 108 monitors a duration during which a user presses a button and compares the duration to a threshold duration. For example, the threshold duration is a predetermined value (e.g., 3 seconds). The predetermined value of a threshold duration associated with one button (e.g., the first button 202) may be equal to and/or different than the predetermined value of a threshold duration associated with another button (e.g., the second button 206). In some examples, the predetermined value is a factory setting. Additionally or alternatively, the predetermined value for a threshold duration may be set and/or adjusted by a vehicle technician and/or a user of the vehicle 100.

For example, when the display controller 108 detects that the first button 202 is pressed, the display controller 108 compares a duration during which the first button 202 is pressed to the threshold duration. In response to determining that the first button 202 is pressed for a duration that is less than the threshold duration, the display 102 presents an interface (e.g., a first feature interface) corresponding to the feature(s) associated with the first button 202. For example, the first feature interface may include input device(s) and/or output device(s) associated with the start-stop engine system. Additionally, in response to determining that the first button 202 is pressed for a duration that is greater than or equal to the threshold duration, the display controller 108 instructs the display 102 to replace the first button 202 with the second button 206 so that the second button 206 is displayed at the button location 204. In some examples, a label that identifies the first button 202 and the second button 206 is located on the infotainment head unit 104 next to the display 102 and adjacent to the button location 204. The label enables a user to identify which button (e.g., the second button 206) and corresponding feature (e.g., the lane-assist system) will be available via the interface 200 upon pressing the first button 202 for the predetermined duration.

Similarly, when the display controller 108 detects that the second button 206 is pressed, the display controller 108 compares a duration during which the second button 206 is pressed to the threshold duration. In response to determining that the second button 206 is pressed for a duration that is less than the threshold duration, the display 102 presents an interface (e.g., a second feature interface) corresponding to the feature(s) associated with the second button 206. For example, the second feature interface may include input device(s) and/or output device(s) associated with the lane-assist system. Further, in response to determining that the second button 206 is pressed for a duration that is greater than or equal to the threshold duration, the display controller 108 instructs the display 102 to replace the second button 206 with the first button 202 so that the first button 202 is displayed at the button location 204.

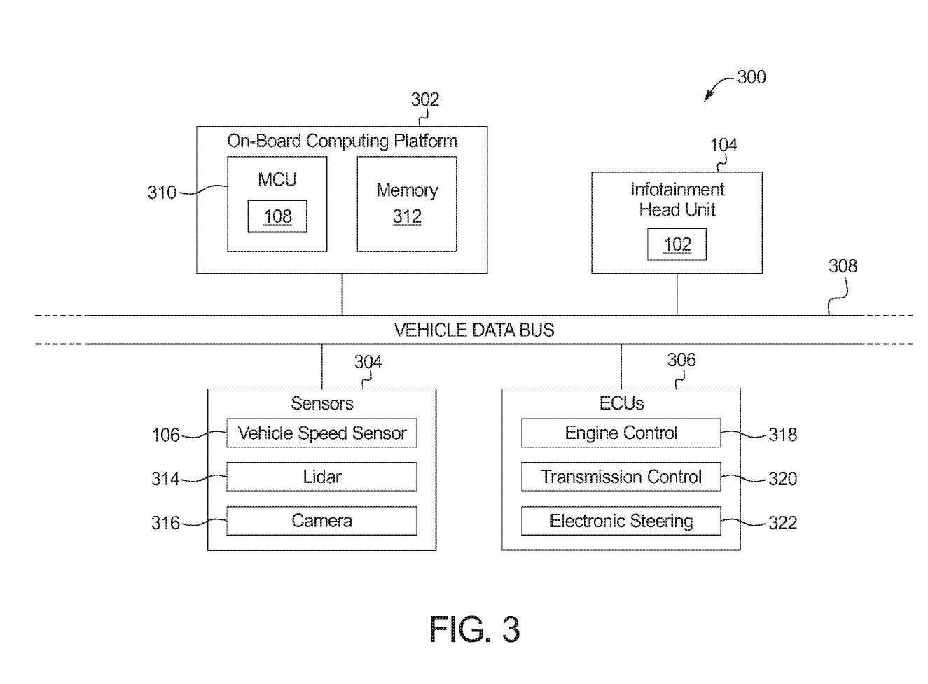

FIG. 3 is a block diagram of electronic components 300 of the vehicle 100. As illustrated in FIG. 3, the electronic components include an on-board computing platform 302, the infotainment head unit 104 that includes the display 102, sensors 304, electronic control units (ECUs) 306, and a vehicle data bus 308.

The on-board computing platform 302 includes a microcontroller unit, controller or processor 310 and memory 312. In some examples, the on-board computing platform 302 is structured to include display controller 108. Alternatively, in some examples, the display controller 108 is incorporated into another electronic control unit (ECU) with its own processor 310 and memory 312. The processor 310 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 312 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). In some examples, the memory 312 includes multiple kinds of memory, particularly volatile memory and non-volatile memory.

The memory 312 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 312, the computer readable medium, and/or within the processor 310 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The sensors 304 are arranged in and around the vehicle 100 to monitor properties of the vehicle 100 and/or an environment in which the vehicle 100 is located. One or more of the sensors 304 may be mounted to measure properties around an exterior of the vehicle 100. Additionally or alternatively, one or more of the sensors 304 may be mounted inside a cabin of the vehicle 100 or in a body of the vehicle 100 (e.g., an engine compartment, wheel wells, etc.) to measure properties in an interior of the vehicle 100. For example, the sensors 304 include accelerometers, odometers, tachometers, pitch and yaw sensors, microphones, tire pressure sensors, biometric sensors and/or sensors of any other suitable type. In the illustrated example, the sensors 304 include the vehicle speed sensor 106 (e.g., a wheel speed sensor), a lidar sensor 314, and a camera 316. The vehicle speed sensor 106 measures a speed of the vehicle 100. The lidar sensor 314, the camera 316, and/or another vision sensor of the vehicle 100 may be utilized to detect lane markings for a lane-assist system of the vehicle 100.

The ECUs 306 monitor and control the subsystems of the vehicle 100. For example, the ECUs 306 are discrete sets of electronics that include their own circuit(s) (e.g., integrated circuits, microprocessors, memory, storage, etc.) and firmware, sensors, actuators, and/or mounting hardware. The ECUs 306 communicate and exchange information via a vehicle data bus (e.g., the vehicle data bus 308). Additionally, the ECUs 306 may communicate properties (e.g., status of the ECUs 306, sensor readings, control state, error and diagnostic codes, etc.) to and/or receive requests from each other. For example, the vehicle 100 may have seventy or more of the ECUs 306 that are positioned in various locations around the vehicle 100 and are communicatively coupled by the vehicle data bus 308. In the illustrated example, the ECUs 306 include an engine control unit 318, a transmission control unit 320, and an electric steering module 322. For example, the engine control unit 318 controls performance of an engine of the vehicle 100, and the transmission control unit 320 monitors and controls a transmission of the vehicle 100. Further, the electric steering module 322 may control steering of the vehicle 100 when a lane-keeping system detects that the vehicle 100 is drifting from its lane on a road.

The vehicle data bus 308 communicatively couples the infotainment head unit 104, the on-board computing platform 302, the sensors 304, and the ECUs 306. In some examples, the vehicle data bus 308 includes one or more data buses. The vehicle data bus 308 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

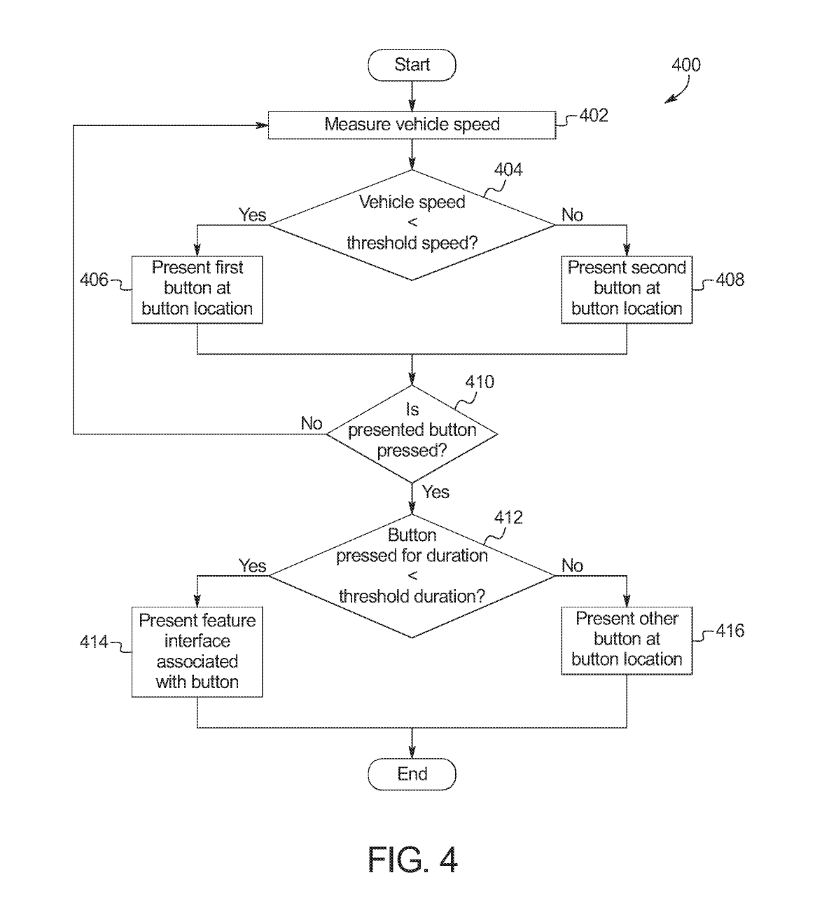

FIG. 4 is a flowchart of an example method to present an interface via a vehicle display based on a speed of a vehicle. The flowchart of FIG. 4 is representative of machine readable instructions that are stored in memory (such as the memory 312 of FIG. 3) and include one or more programs which, when executed by a processor (such as the processor 310 of FIG. 3), cause the vehicle 100 to implement the example display controller 108 of FIGS. 1 and 3. While the example program is described with reference to the flowchart illustrated in FIG. 4, many other methods of implementing the example display controller 108 of FIGS. 1 and 3 may alternatively be used. For example, the order of execution of the blocks may be rearranged, changed, eliminated, and/or combined to perform the method 400. Further, because the method 400 is disclosed in connection with the components of FIGS. 1-3, some functions of those components will not be described in detail below.

Initially, at block 402, the vehicle speed sensor 106 measures a speed of the vehicle (e.g., a vehicle speed). At block 404, the display controller 108 determines whether the vehicle speed is less than a threshold speed. If the vehicle speed is less than the threshold speed, the method 400 continues to block 406 at which the display 102 presents a first button 202 at a button location 204 of the interface 200. For example, at block 406, the display controller 108 instructs the display 102 to present the first button 202 at the button location 204. Otherwise, if the vehicle speed is greater than or equal to the threshold speed, the method 400 continues to block 408 at which the display 102 presents the second button 206 at the button location 204 of the interface 200. For example, at block 408, the display controller 108 instructs the display 102 to present the second button 206 at the button location 204.

Upon displaying the first button 202 at block 406 or the second button 206 at block 408, the method continues to block 410 at which the display controller 108 determines whether the presented button (e.g., the first button 202 or the second button 206) has been pressed (e.g., by a user). If the display controller 108 determines that the presented button has not been pressed, the method 400 returns to block 402 to repeat blocks 402, 404, 406, 408, 410. Otherwise, if the display controller 108 determines that the presented button has been pressed, the display controller 108 determines whether the presented button has been pressed for a duration less than a threshold duration at block 412.

If the display controller 108 determines that the presented button is pressed for a duration less than the threshold duration, the method 400 continues to block 414 at which the display 102 presents a feature interface associated with the presented button. For example, if the displayed button is the first button 202 and is pressed for a duration less than the threshold duration, the display controller 108 instructs the display 102 to navigate to a first feature interface (e.g., a start-stop engine system interface) associated with the first button 202 (e.g., a start-stop engine system button). If the displayed button is the second button 206 and is pressed for a duration less than the threshold duration, the display controller 108 instructs the display 102 to navigate to a second feature interface (e.g., a lane-assist system interface) associated with the second button 206 (e.g., a lane-assist system button).

Otherwise, if the display controller 108 determines that the presented button is pressed for a duration greater than or equal to the threshold duration, the method 400 continues to block 416 at which the display 102 presents the other button (e.g., the second button 206 or the first button 202) at the button location 204 of the interface 200. For example, if the displayed button is the first button 202 and is pressed for a duration greater than or equal to the threshold duration, the display controller 108 instructs the display 102 to replace the first button 202 with the second button 206 such that the second button 206 is displayed at the button location 204 of the interface 200. If the displayed button is the second button 206 and is pressed for a duration greater than or equal to the threshold duration, the display controller 108 instructs the display 102 to replace the second button 206 with the first button 202 such that the first button 202 is displayed at the button location 204 of the interface 200. Upon completing block 414 or block 416, the method 400 ends.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
a speed sensor to measure a vehicle speed;
a display controller to compare the vehicle speed to a threshold; and
a display to:
present, in response to the vehicle speed being less than the threshold, a first button at a button location; and
present, in response to the vehicle speed being greater than or equal to the threshold, a second button at the button location.

2. The vehicle of claim 1, wherein the display presents the first button or the second button at the button location.

3. The vehicle of claim 1, wherein the first button is associated with a first vehicle feature and the second button is associated with a second vehicle feature.

4. The vehicle of claim 3, wherein the first vehicle feature is a start-stop engine system and the second vehicle feature is a lane-assist system.

5. The vehicle of claim 1, wherein the display is a touch screen.

6. The vehicle of claim 1, wherein the display controller detects when the first button is pressed by a user.

7. The vehicle of claim 6, wherein, in response to the display controller determining the first button is pressed for a duration less than a threshold duration, the display presents a first feature interface associated with the first button.

8. The vehicle of claim 7, wherein, in response to the display controller determining the duration is greater than or equal to the threshold duration, the display presents the second button at the button location.

9. The vehicle of claim 1, wherein the display controller detects when the second button is pressed by a user.

10. The vehicle of claim 9, wherein, in response to the display controller determining the second button is pressed for a duration less than a threshold duration, the display presents a second feature interface associated with the second button.

11. The vehicle of claim 10, wherein, in response to the display controller determining the duration is greater than or equal to the threshold duration, the display presents the first button at the button location.

12. A method for presenting a button on a vehicle display, the method comprising:
comparing, via a processor, a speed of a vehicle to a threshold;
presenting, via a display of the vehicle, a first button at a button location in response to the speed being less than the threshold; and
presenting a second button at the button location in response to the speed being greater than or equal to the threshold.

13. The method of claim 12, further including measuring the speed of the vehicle via a vehicle speed sensor of the vehicle.

14. The method of claim 12, wherein the first button is associated with a first vehicle feature and the second button is associated with a second vehicle feature.

15. The method of claim 12, further including detecting when at least one of the first button and the second button is pressed by a user.

16. The method of claim 15, further including presenting, in response to determining the first button is pressed for a duration less than a threshold duration, a first feature interface associated with the first button.

17. The vehicle of claim 16, further including presenting, in response to detecting the duration is greater than or equal to the threshold duration, the second button at the button location.

18. The vehicle of claim 15, further including presenting, in response determining the second button is selected for a duration less than a threshold duration, a second feature interface associated with the second button.

19. The vehicle of claim 18, further including presenting, in response to determining the duration is greater than or equal to the threshold duration, the first button at the button location.

20. A tangible computer storage medium comprising instructions, which, when executed, cause a machine to:
compare a speed of a vehicle to a threshold;
present, via a display of the vehicle, a first button at a button location in response to the speed being less than the threshold; and
present a second button at the button location in response to the speed being greater than or equal to the threshold.
